(19) United States
(12) Patent Application Publication
(10) Pub. No.: US 2012/0193839 A1
(43) Pub. Date: Aug. 2, 2012

(54) Use of moulding compositions

(75) Inventors: Günter Margraf, Dormagen (DE); Detlev Joachimi, Krefeld (DE)

(73) Assignee: LANXESS DEUTSCHLAND GMBH, Leverkusen (DE)

(21) Appl. No.: 13/358,536

(22) Filed: Jan. 26, 2012

(30) Foreign Application Priority Data
Jan. 28, 2011 (EP) 11152464.1

(51) Int. Cl. B29C 49/04; B29C 49/00; B29C 45/00; B29C 47/00

(52) U.S. Cl. 264/540; 264/239; 264/523; 264/328.1

(57) ABSTRACT

The present invention relates to the use of moulding compositions comprising A) at least one polyamide and/or copolyamide, B) at least one copolymer comprising at least one olefin and at least one acrylate of an aliphatic alcohol, C) at least one di- or polyfunctional additive which has branching or chain-extending effect, D) at least one impact modifier differing from components B) and C), and optionally also E) other additives differing from the above mentioned components, to produce products, components, mouldings, moulded parts or semifinished products with increased resistance to crankcase gases and/or constituents of these, and also to a process for improving products, mouldings, components or moulded parts in motor vehicles, preferably in internal combustion engines of these, in respect of their resistance to crankcase gases, by using the said moulding compositions to produce the said products.

The present invention relates to the use of moulding compositions comprising A) at least one polyamide and/or copolyamide, B) at least one copolymer comprising at least one olefin and at least one acrylate of an aliphatic alcohol, C) at least one di- or polyfunctional additive which has branching or chain-extending effect, D) at least one impact modifier differing from components B) and C), and optionally also E) at least one other additive differing from the abovementioned components, to produce semifinished products or products, components, moulded parts or mouldings to be produced therefrom with increased resistance to crankcase gases and/or constituents of these, and also to a process for improving products, mouldings, components or moulded parts in motor vehicles, preferably in internal combustion engines of these, in respect of their resistance to crankcase gases, by using the said moulding compositions to produce the said products.

### BACKGROUND OF THE INVENTION

In recent years, engineering thermoplastics have increasingly replaced traditional metal structures in the engine compartment of motor vehicles. The reason for this is not only the reduction of component weights and advantages in the production process (cost reduction, function integration, materials- and process-related design freedom, smoother inner surfaces, etc) but also in particular the excellent properties of the materials, for example high long-term service temperatures, high dynamic strength and resistance to heat-aging and chemicals (“Rohrsysteme im Motorraum” [Pipe systems in the engine compartment], Kunststoffe 11/2007, Carl Hanser Verlag, 126-128). A problematic factor for many engineering thermoplastics has proven to be resistance to crankcase gases or blow-by gases and/or constituents of these. Some of the exhaust gases produced in the engine compartment of motor vehicles during the combustion process are entrained into the cylinder crankcase, from where they are returned through a hose to the engine for combustion. This gas is known as crankcase gas and can form a condensate deposit and damage the polymer materials used at an exposed site. The constitution of the condensate varies considerably as a function of the operating conditions of the engine. It is mainly composed of fuel, engine oil and an aqueous acidic phase in particular comprising nitric acid. EP 1 537 301 B1 relates to an apparatus and a method for purifying crankcase gas. DE 101 27 819 A1 and DE 20 2007 003 094 U1 disclose oil separators and oil preseparators for crankcase gas. DE 10 2008 018 771 A1 describes a crankcase gas return apparatus.

In contrast to the cited prior art which provides cleaning, discharge or separation of the crankcase gas, the object of the present invention consists in providing products, components, moulded parts or mouldings with increased resistance to crankcase gases and/or constituents of these.

For the purposes of the present invention, products, components, moulded parts or mouldings are used in motor vehicles or in the motor vehicle industry and are preferably air-conducting components in motor vehicles, where these are in contact with crankcase gases and/or constituents of these. They are particularly preferably clean-air lines, charge-air pipes, intake pipes, valve covers and crankcase vents. Clean-air lines connect the air filter to the turbocharger in turbocharged internal combustion engines. In non-turbocharged engines, clean-air lines connect the air filter to the intake pipes.

For the purposes of the present invention, charge-air pipes are the connection pipes between turbocharger and heat exchanger/charge-air cooler, and also between heat exchanger and intake pipe, in internal combustion engines.

Intake pipes are components which have been attached directly on the cylinder head of internal combustion engines and which introduce the air, or air-fuel mixture, from the suction intake to the inlet ducts of the individual cylinders.

The valve cover, also termed cylinder-head cover, is the uppermost part of a (vertical) internal combustion engine, preferably of a four-cycle internal combustion engine. It covers the upper operating elements of the valve gear and prevents escape of the lubricating oil into the environment, and also prevents ingress of air into the engine.

The crankcase vent takes the crankcase gases that have emerged from the combustion chamber of an internal combustion engine into the crankcase chamber by way of the region between pistons or piston rings (piston ring gaps) and cylinders, and conducts them to the suction intake system of the engine.

Examples of materials currently used to produce clean-air lines and charge-air pipes are elastomeric block copolyamides and thermoplastic polyester elastomers (“Luftführung unter der Motorhaube” [Air management under the engine hood], Kunststoffe 8/2001, Carl Hanser Verlag, 79-81).

### SUMMARY OF THE INVENTION

Surprisingly, it has now been found that products, components, moulded parts or mouldings with increased resistance to crankcase gases and/or constituents of these are accessible via the use of moulding compositions comprising polyamides and/or copolyamides of moderate viscosity, copolymers of at least one olefin, preferably of an a-olefin, with at least one methacrylate or acrylate of an aliphatic alcohol, where the MFI (Melt Flow Index) of the copolymer is greater than 10 g/10 min, preferably greater than 150 g/10 min and particularly preferably greater than 300 g/10 min, with epoxidized vegetable oil or with other di- or polyfunctional additives which have branching or chain-extending effect, and with impact modifiers, and also optionally with further additives.

The present invention provides the use of moulding compositions comprising
A) from 40 to 98.98 parts by weight of at least one polyamide and/or copolyamide,
B) from 1 to 10 parts by weight, preferably from 2 to 8 parts by weight, particularly preferably from 3 to 6 parts by weight, of at least one copolymer comprising at least one olefin, preferably a-olefin, and at least one acrylate of an aliphatic alcohol, where the MFI (Melt Flow Index) of the copolymer B) is greater than 10 g/10 min, preferably greater than 150 g/10 min and particularly preferably greater than 300 g/10 min, and the MFI is determined or measured at 190° C. using a load of 2.16 kg,
C) from 0.01 to 10 parts by weight, preferably from 0.1 to 6 parts by weight, particularly preferably from 0.5 to 5 parts by weight, of at least one di- or polyfunctional additive which has branching or chain-extending effect and which comprises, per molecule, at least two and at most 15 functional groups which have branching or chain-extending effect, and
D) from 0.01 to 40 parts by weight, preferably from 5 to 39 parts by weight, particularly preferably from 15 to 35 parts by weight, of at least one impact modifier differing from components B) and C)

to improve the resistance of products, mouldings, components, moulded parts or semifinished products for motor vehicles, preferably in internal combustion engines of these, in respect of their resistance to crankcase gases and/or constituents of those.

### DETAILED DESCRIPTION OF THE INVENTION

In one preferred embodiment, the thermoplastic moulding compositions according to the invention can also comprise from 0.001 to 5 parts by weight of at least one other additive E) differing from the abovementioned components, in addition to components A), B), C) and D).

According to the invention, comprising means including and does not mean composed of. In one particularly preferred embodiment, the moulding compositions according to the invention are composed of components A), B), C) and D), and also optionally E). According to the invention, it is preferable that the copolymer in process step B) is composed of at least one olefin, preferably a-olefin, and at least one acrylate of an aliphatic alcohol.

For clarification, it should be noted that the scope of the invention encompasses any desired combination of all of the definitions and parameters listed in this description in general terms or in preferred ranges.

The products, components, moulded parts, mouldings or semifinished products to be produced by using the moulding compositions to be used according to the invention are air-conducting components in motor vehicles, in particular in internal combustion engines of these, preferably clean-air lines, charge-air pipes, in particular charge-air feed line or else charge-air return line, intake pipes, crankcase vents and transmission vents.

For the purposes of the present invention, resistance to crankcase gases and/or constituents of these means that, after contact with crankcase gases and/or constituents of these, the products, moulded parts, components or mouldings according to the invention
a) exhibit an increase in weight of less than 7.5%, preferably less than 5%, as a consequence of absorption of test fluid,
b) exhibit no superficial damage (e.g. cracking and/or blistering with inclusion of test fluid) and
c) exhibit mechanical properties only slightly altered in comparison with the unaged condition. For the purposes of the present invention, slight alteration in comparison with the unaged condition means that
   1. the reduction of Shore D hardness after ageing in comparison with the unaged condition is less than 10%, preferably less than 7.5%, and
2. the reduction of tensile strength after ageing in comparison with the unaged condition is less than 40%, preferably less than 25%.

Constituents of crankcase gases for the purposes of the present invention are fuels, engine oil, transmission oil, aqueous acids, and also inorganic combustion gases, in particular nitrogen oxides.

The application further provides a process for improving products, mouldings, components or moulded parts in motor vehicles, preferably in internal combustion engines of these, in respect of their resistance to crankcase gases, characterized in that production of these uses moulding compositions comprising
A) from 40 to 98.98 parts by weight of at least one polyamide and/or copolyamide,
B) from 1 to 10 parts by weight, preferably from 2 to 8 parts by weight, particularly preferably from 3 to 6 parts by weight, of at least one copolymer comprising at least one olefin, preferably a-olefin, and at least one acrylate of an aliphatic alcohol, where the MFI (Melt Flow Index) of the copolymer B) is greater than 10 g/10 min, preferably greater than 150 g/10 min and particularly preferably greater than 300 g/10 min, and the MFI is determined or measured at 190° C. using a load of 2.16 kg,
C) from 0.01 to 10 parts by weight, preferably from 0.1 to 6 parts by weight, particularly preferably from 0.5 to 5 parts by weight, of at least one di- or polyfunctional additive which has branching or chain-extending effect and which comprises, per molecule, at least two and at most 15 functional groups which have branching or chain-extending effect, and
D) from 0.01 to 40 parts by weight, preferably from 5 to 39 parts by weight, particularly preferably from 15 to 35 parts by weight, of at least one impact modifier differing from components B) and C).

There are a very wide variety of known procedures for producing the polyamides to be used as component A), using, as a function of desired final product, different monomer units, different chain regulators to adjust to a desired molecular weight, or else monomers having reactive groups for intended subsequent post-treatments.

Processes which are relevant industrially for producing the polyamides to be used as component A) in the moulding composition according to the invention preferably proceed by way of the term polycondensation in the melt. According to the invention, polycondensation also covers the hydrolytic polymerization of lactams.

According to the invention, preferred polyamides are semicrystalline or amorphous polyamides which can be produced from diamines and dicarboxylic acids and/or lactams having at least 5 ring members or from corresponding amino acids. Preferred starting materials that can be used are aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, pentamethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediarnines, xylylene-diamines, aminocarboxylic acids, in particular aminocaproic acid, or the corresponding lactams. Copolyamides made of a plurality of the monomers mentioned are included.

Particular preference is given to nylon-6, nylon-6,6, and copolyamides comprising caprolactam as comonomer.

The materials can moreover comprise proportions of recycled polyamide moulding compositions and/or fibre recyclates.

The moulding compositions to be used according to the invention to produce the components, moulded parts, mouldings or semifinished products preferably comprise, as main resin, polyamides and/or copolyamides with relative viscosity η from 2.3 to 4.0 particularly preferably from 2.7 to 3.5, where relative viscosity is measured on a 1% by weight solution in meta-cresol at 25° C.

The moulding composition to be used according to the invention to produce the products, components, moulded parts, mouldings or semifinished products comprises at least one copolymer B) made of at least one olefin, preferably a-olefin, and of at least one acrylate of an aliphatic alcohol, where the MFI of the copolymer B) is greater than 10 g/10 min, preferably greater than 150 g/10 min and particularly preferably greater than 300 g/10 min, and the MFI is determined or measured at 190° C. using a load of 2.16 kg. In one preferred embodiment, the copolymer B) is composed of less than 4 parts by weight, particularly preferably less than 1.5 parts by weight and very particularly preferably 0 part by weight, of monomer units which comprise other reactive functional groups selected from the group consisting of epoxides, oxetanes, anhydrides, imides, aziridines, furans, acids, amines, oxazolines.

For information on MFI, its definition and its determination reference may be made to B. Carlowitz, Tabellarische Übersicht über die Prüfung von Kunststoffen [Tabular overview of the testing of plastics], 6th Edition, Giesel Verlag für Publizität, 1992. Accordingly the MFI is the mass of a specimen which is forced through a die within a certain time under specified conditions. DIN 53 735 (1988) and ISO 1133-1981 specify the method to be used for thermoplastics here. MFI serves to characterize the flow behaviour (tested on moulding compositions) of a thermoplastic under certain conditions of pressure and temperature. It is a measure of the viscosity of a plastics melt. It can be used to draw conclusions about the degree of polymerization, i.e. the average number of monomer units in a molecule.

MFI to ISO 1133 is determined by using a capillary rheometer, where the material (pellets or powder) is melted in a heatable cylinder and forced through a defined die (capillary) by the pressure generated by the superposed load. The mass of polymer melt (known as extrudate) discharged is determined as a function of time. The melt extrudates must be weighed to obtain the mass flow rate of the melt.

MFI=mass/10 min

The unit for the MFI is g/10 min. For the purposes of the present invention, MFI is determined and measured at 190° C. using a load of 2.16 kg.

Olefins, preferably a-olefins, suitable as constituent of the copolymers B) preferably have from 2 to 10 carbon atoms and can be unsubstituted or can have substitution by one or more aliphatic, cycloaliphatic or aromatic groups.

Preferred olefins are those selected from the group consisting of ethene, propene, 1-butene, 1-pentene, 1-hexene, 1-octene, 3-methyl-1-pentene. Particularly preferred olefins are ethene and propene, and very particular preference is given to ethene.

Mixtures of the olefins described are likewise suitable.

In another preferred embodiment, the other reactive functional groups of the copolymer B), selected from the group consisting of epoxides, oxetanes, anhydrides, imides, aziridines, furans, acids, amines, oxazolines, are introduced exclusively by way of the olefins into the copolymer B).

The content of the olefin in the copolymer B) is from 50 to 90 parts by weight, preferably from 55 to 75 parts by weight.

The copolymer B) is further defined via the second constituent alongside the olefin. The second constituent used comprises alkyl esters or arylalkyl esters of acrylic acid, the alkyl or arylalkyl group of which is formed from 1 to 30 carbon atoms. The alkyl or arylalkyl group can be a linear or branched group, and can also comprise cycloaliphatic or aromatic groups, and can also have substitution by one or more ether or thioether functions. Other acrylates suitable in this context are those synthesized from an alcohol component based on oligoethylene glycol or on oligopropylene glycol having only one hydroxy group and at most 30 carbon atoms.

The alkyl group or arylalkyl group of the acrylate can preferably be selected from the group consisting of methyl, ethyl, n-propyl, isopropyl, n-butyl, isobutyl, tert-butyl, sec-butyl, 1-pentyl, 1-hexyl, 2-hexyl, 3-hexyl, 1-heptyl, 3-heptyl, 1-octyl, 1-(2-ethyl)hexyl, 1-nonyl, 1-decyl, 1-dodecyl, 1-lauryl or 1-octadecyl. Preference is given to alkyl groups or arylalkyl groups having from 6 to 20 carbon atoms. Particular preference is also given to branched alkyl groups, which give a lower glass transition temperature T_{O} than linear alkyl groups having the same number of carbon atoms.

According to the invention, particular preference is given to copolymers B) in which the olefin is copolymerized with 2-ethylhexyl acrylate. Mixtures of the acrylates described are likewise suitable.

It is preferable here to use more than 60 parts by weight, particularly more than 90 parts by weight and very particularly 100 parts by weight, of 2-ethylhexyl acrylate, based on the total amount of acrylate in the copolymer B).

In another preferred embodiment, the other reactive functional groups selected from the group consisting of epoxides, oxetanes, anhydrides, imides, aziridines, furans, acids, amines, oxazolines, of the copolymer B) are introduced exclusively by way of the acrylates into the copolymer B).

The content of the acrylates in the copolymer B) is from 10 to 50 parts by weight, preferably from 25 to 45 parts by weight.

The moulding composition to be used to produce the mouldings, moulded parts, products or components according to the invention comprises, as component C), at least one di- or polyfunctional additive having branching or chain-extending effect comprising, per molecule, at least two and at most 15 functional groups having branching or chain-extending effect. Branching or chain-extending additives that can be used comprise low-molecular-weight and oligomeric compounds which have, per molecule, at least two and at most 15 functional groups having branching or chain-extending effect, where these can react with primary and/or secondary amino groups, and/or with amide groups and/or with carboxylic acid groups. Functional groups having chain-extending effect are preferably isocyanates, capped isocyanates, epoxides, maleic anhydride, oxazolines, oxazines, oxazolones.

Particular preference is given to diepoxides based on diglycidyl ether, in particular derived from bisphenol or epichlorohydrin, based on amine epoxy resin, in particular derived from aniline and epichlorohydrin, based on diglycidyl esters of cycloaliphatic dicarboxylic acids and epichlorohydrin, individually or in mixtures, and also 2,2-bis[p-hydroxyphenyl]propane diglycidyl ether, bis[p-(N-methyl-N-2,3-epoxypropylamino)phenyl]methane, and also epoxidized fatty acid esters of glycerol having at least two and at most 15 epoxy groups per molecule.

Particularly preference is given to glycidyl ethers, and very particular preference is given to bisphenol A diglycidyl ether and epoxidized fatty acid esters of glycerol, and also epoxidized soya oil (CAS 8013-07-8).

Epoxidized soya oil is known as co-stabilizer and plasticizer for polyvinyl chloride (Plastics Additives Handbook, 5th Edition, Hanser-Verlag, Munich, 2001, pp. 460-462). It is in particular used in polyvinyl chloride seals of metal closures for the airtight closure of glass containers and bottles.

The following are particularly preferably suitable for branching/chain extension:
1. Poly- or oligoglycidyl or poly(B-methylglycidyl) ethers, preferably obtainable via reaction of a compound having at least two free alcoholic hydroxy groups and/or phenolic hydroxy groups with a suitably substituted epichlorohydrin under alkaline conditions, or in the presence of an acidic catalyst and subsequent alkali treatment.
Poly- or oligoglycidyl or poly(B-methylglycidyl) ethers preferably derive from acyclic alcohols, such as ethylene glycol, diethylene glycol and higher poly(oxyethylene)glycols, propane-1,2-diol, poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, or from polyepichlorohydrins.
However, they also preferably derive from cycloaliphatic alcohols, such as 1,3- or 1,4-dihydroxycyclohexane, bis(4-hydroxycyclohexyl)methane, 2,2-bis(4-hydroxycyclo-hexyl)propane or 1,1-bis(hydroxymethyl)cyclohex-3-ene, or have aromatic rings, an example being N,N-bis(2-hydroxyethyl)aniline or p,p′-bis(2-hydroxyethylamino)diphenylmethane.
The epoxy compounds can also preferably derive from mononuclear phenols, in particular from resorcinol or hydroquinone; or are based on polynuclear phenols, in particular on bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulphone or condensates obtained from phenols with formaldehyde under acidic conditions, in particular phenol novolaks.
2. Poly- or oligo(N-glycidyl) compounds preferably obtainable via dehydrochlorination of the reaction products of epichlorohydrin with amines, where these comprise at least two amino hydrogen atoms. These amines preferably comprise aniline, toluidine, n-butylamine, bis(4-aminophenyl)methane, m-xylylenediamine or bis(4-methylaminophenyl)methane, or else N,N,O-triglycidyl-m-aminophenyl or N,N,O-triglycidyl-p-aminophenol.
However, among other preferred poly(N-glycidyl) compounds are N,N′-diglycidyl derivatives of cycloalkylene ureas, particularly preferably ethylene urea or 1,3-propylene urea, and N,N′-diglycidyl derivatives of hydantoins, in particular 5,5-dimethylhydantoin.
3. Poly- or oligo(S-glycidyl) compounds, in particular di-S-glycidyl derivatives which preferably derive from dithiols, preferably ethane-1,2-dithiol or bis(4-mercaptomethyl-phenyl)ether.
4. Epoxidized fatty acid esters of glycerol, in particular epoxidized vegetable oils. They are obtained via epoxidation of the reactive olefin groups of triglycerides of unsaturated fatty acids. Epoxidized fatty acid esters of glycerol can be produced by starting from unsaturated fatty acid esters of glycerol, preferably from vegetable oils, and from organic peroxycarboxylic acids (Prilezhaev reaction). Processes for producing epoxidized vegetable oils are described by way of example in Smith, March, March's Advanced Organic Chemistry (5th Edition, Wiley-Interscience, New York, 2001). Preferred epoxidized fatty acid esters of glycerol are vegetable oils. Particularly preferred epoxidized fatty acid ester of glycerol according to the invention is epoxidized soya oil (CAS 8013-07-8).

The moulding composition to be used to produce the mouldings, moulded parts, products, components or semifinished products according to the invention comprises at least one impact modifier D) differing from components B) and C). Impact modifiers are often also termed elastomer modifiers, elastomers, modifiers or rubbers.

These preferably comprise copolymers, with the exception of copolyamides, where these are preferably composed of at least two monomers from the group of ethylene, propylene, butadiene, isobutene, isoprene, chloroprene, vinyl acetate, styrene, acrylonitrile and acrylates having from 1 to 18 carbon atoms in the alcohol component.

Polymers of this type are described by way of example in Houben-Weyl “Methoden der organischen Chemie” [Methods of organic chemistry], Volume 14/1 (Georg-Thieme-Verlag, Stuttgart, 1961), pp. 392 to 406 and Odian “Principles of Polymerization” (Fourth Edition, Wiley-Interscience, 2004).

Some impact modifiers to be used with preference according to the present invention are described below.

Preferred types of these impact modifiers to be used as component D) are those known as ethylene-propylene rubbers (EPM) or ethylene-propylene-diene (EPDM) rubbers.

EPM rubbers generally have practically no residual double bonds, whereas EPDM rubbers can have from 1 to 20 double bonds per 100 carbon atoms.

Preferred diene monomers used for EPDM rubbers are conjugated dienes such as isoprene or butadiene, non-conjugated dienes having from 5 to 25 carbon atoms, e.g. penta-1,4-diene, hexa-1,4-diene, hexa-1,5-diene, 2,5-dimethylhexa-1,5-diene and octa-1,4-diene, cyclic dienes such as cyclopentadiene, cyclohexadiene, cyclooctadiene and dicyclopentadiene, and also alkenylnorbornenes, such as 5-ethylidene-2-norbornene, 5-butylidene-2-norbornene, 2-methallyl-5-norbornene, 2-isopropenyl-5-norbornene and tricyclodienes such as 3-methyltricyclo[5.2 1.0 2.6]-3,8-decadiene or a mixture of these. Particular preference is given to hexa-1,5-diene, 5-ethylidenenorbornene or dicyclopentadiene. The diene content of the EPDM rubbers is preferably from 0.5 to 50, in particular from 1 to 8% by weight, based on the total weight of the rubber.

EPM rubbers or EPDM rubbers can preferably also have been grafted with reactive carboxylic acids or with derivatives of these. The following may be mentioned here with preference: acrylic acid, methacrylic acid or derivatives of these, in particular glycidyl(meth)acrylate, and also maleic anhydride.

The rubbers can also comprise dicarboxylic acids, preferably maleic acid or fumaric acid or derivatives of the said acids, preferably esters and anhydrides, and/or monomers comprising epoxy groups. These dicarboxylic acid derivatives or monomers comprising epoxy groups are preferably incorporated into the rubber via addition, to the monomer mixture, of monomers of the general formulae (I) or (II) or (III) or (IV), where these comprise dicarboxylic acid groups and, respectively, epoxy groups,

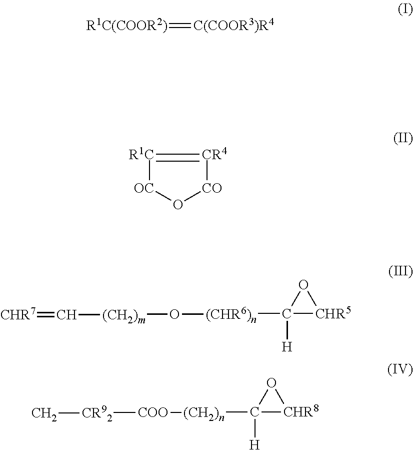

in which

R¹ to R⁹ are hydrogen or alkyl groups having from I to 6 carbon atoms,

m is an integer from 0 to 20 (inclusive of terminal values), and

n is an integer from 0 to 10 (inclusive of terminal values).

The moieties R′ to R⁹ are preferably hydrogen, where m is 0 or 1 and n is 1. The corresponding compounds are maleic acid, fumaric acid, maleic anhydride, allyl glycidyl ether and vinyl glycidyl ether.

According to the invention, preferred compounds of the formulae (I), (II) and (IV) are maleic acid and maleic anhydride.

The copolymers are preferably composed of from 50 to 98 parts by weight of ethylene, and from 0.1 to 20 parts by weight of monomers comprising epoxy groups and/or monomers comprising anhydride groups.

It is also possible to use vinyl esters and vinyl ethers as other comonomers.

The ethylene copolymers described above can be produced by known processes, preferably via random copolymerization under high pressure and at elevated temperature. Corresponding processes are well known.

Other preferred elastomers are emulsion polymers, where the production of these has been described in the literature (Bernd Tieke, “Makromolekulare Chemie”, Wiley-VCH, Weinheim, 2005, pp. 86-90; George Odian, “Principles of Polymerization”, Wiley-interscience, 2004, pp. 350-371).

In principle, it is possible to use elastomers of homogenous structure or else those having a shell structure. The shell-type structure is determined via the sequence of addition of the individual monomers; this sequence of addition also affects the morphology of the polymers.

Butadiene and isoprene, and also mixtures of these, may be mentioned here merely as representatives of monomers for producing the rubber portion of the elastomers. The said monomers can be copolymerized with other monomers, preferably styrene, acrylonitrile, and vinyl ethers.

The soft phase or rubber phase of the elastomers, preferably with glass transition temperature below 0° C., can be the core, the outer envelope or an intermediate shell, in particular in the case of elastomers having a structure comprising more than two shells; in multishell elastomers it is also possible that a plurality of shells are composed of a rubber phase.

If the structure of the elastomer involves not only the rubber phase but also one or more hard components, preferably with glass transition temperatures above 20° C., these are generally produced via polymerization of styrene, acrylonitrile, methacrylonitrile, a-methylstyrene, or p-methylstyrene as main monomers. It is also possible here to use relatively small proportions of other comonomers, alongside these.

In some instances it has proved advantageous to use emulsion polymers which have reactive groups at the surface. Groups of this type are preferably epoxy, carboxy, latent carboxy, amino or amide groups, or else functional groups which can be introduced via concomitant use of monomers of the general formula (V)

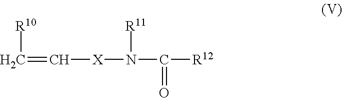

in which the definitions of the substituents can be as follows:
R¹⁰ hydrogen or a C₁-C₄-alkyl group,
R¹¹ hydrogen, a C₁-C₈-alkyl group or a mono-, bi- or tricyclic homo- or heteroaromatic group, in particular phenyl,
R¹² hydrogen, a C₁-C₁₀-alkyl group, —OR¹³, or a mono-, bi- or tricyclic homo- or heteroaromatic group, in particular phenyl,
R¹³ a C₁-C₈-alkyl group or a mono-, bi- or tricyclic homo- or heteroaromatic group, in particular phenyl, which can optionally have substitution by O- or N-containing groups,
X a chemical bond, a C₁-C₁₀-alkylene group, or a mono-, bi- or tricyclic homo- or heteroaromatic group, in particular phenylene, or

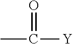

Y O—Z or NH—Z and
Z a C₁-C₁₀-alkylene group, or a mono-, bi- or tricyclic homo- or heteroaromatic group, in particular phenyl.

The graft monomers described in EP 0 208 187 A2 are also suitable for introducing reactive groups at the surface.

Other examples that may be mentioned are acrylamide and methacrylatnide, and preferably N-tert-butylaminoethyl methacrylate, N,N-dimethylaminoethyl acrylate, N,N-dimethylaminomethyl acrylate or N,N-diethylaminoethyl acrylate.

The particles of the rubber phase can moreover also have been crosslinked. Preferred monomers used as crosslinking agents are buta-1,3-diene, divinylbenzene, diallyl phthalate and dihydro-dicyclopentadienyl acrylate, and also the compounds described in EP 0 050 265 A1.

It is also possible to use the compounds known as graftlinking monomers, i.e. monomers having two or more polymerizable double bonds, where these react at different rates during the polymerization reaction. It is preferable to use compounds of this type in which at least one reactive group polymerizes at about the same rate as the other monomers, whereas the other reactive group(s) polymerize(s) by way of example markedly more slowly. The different polymerization rates give rise to a certain proportion of unsaturated double bonds in the rubber. If another phase is then grafted onto this type of rubber, at least some of the double bonds present in the rubber react with the graft monomers to form chemical bonds, i.e. there is at least some chemical bonding linking the grafted-on phase to the graft base.

Preferred graftlinking monomers are monomers comprising allyl groups, particularly preferably allyl esters of ethylenically unsaturated carboxylic acids, particularly preferably allyl acrylate, allyl methacrylate, diallyl maleate, diallyl fumarate, diallyl itaconate or the corresponding monoallyl compounds of the said dicarboxylic acids. Alongside these, there is a wide variety of other suitable graftlinking monomers; reference may be made here by way of example to U.S. Pat. No. 4,148,846 and U.S. Pat. No. 4,327,201 for further details.

Some emulsion polymers preferred according to the invention are listed below. Mention may first be made here of graft polymers having a core and at least one outer shell and having the following structure:

TABLE 1

| Type | Monomers for the core | Monomers for the envelope |
|---|---|---|
| I | Buta-1,3-diene, isoprene, | Styrene, acrylonitrile |
| | styrene, acrylonitrile, | |
| | or a mixture of these | |
| II | as I, but with concomitant | as I |
| | use of crosslinking agents | |
| III | as I or II | Buta-1,3-diene, isoprene |
| IV | as I or II | as I or III, but |
| | | with concomitant use of |
| | | monomers having reactive groups |
| | | as described herein |
| V | Styrene, acrylonitrile or a | first envelope made of monomers |
| | mixture of these | as described in I and II for the core |
| | | second envelope as described in |
| | | I or IV for the envelope |

Instead of graft polymers having a multishell structure, it is also possible to use homogeneous, i.e. single-shell, elastomers made of buta-1,3-diene, of isoprene or of copolymers of these. Again, these products can be produced via concomitant use of crosslinking monomers or of monomers having reactive groups.

Preferred emulsion polymers are copolymers of ethylene with comonomers which provide reactive groups.

The elastomers described can also be produced by other conventional processes, preferably via suspension polymerization. Preference is likewise given to silicone rubbers as described in DE 3 725 576 A1, EP 0 235 690 A2, DE 3 800 603 A1 and EP 0 319 290 A1.

It is also possible, of course, to use mixtures of the types of rubber listed above.

The moulding compositions to be used according to the invention to produce the products, components, moulded parts, mouldings or semifinished products particularly preferably comprise at least one impact modifier D) of EPM type or of EPDM type.

The moulding composition to be used according to the invention to produce mouldings, moulded parts, products, components or semifinished products can also comprise at least one additive E) which also differs from components A), B), C) and D). Additives E) preferred for the purposes of the present invention are stabilizers (Plastics Additives Handbook, 5th Edition, Hanser-Verlag, Munich, 2001, pp. 80-84, 352-361), nucleating agents (Plastics Additives Handbook, 5th Edition, Hanser-Verlag, Munich, 2001, pp. 949-959, 966), lubricants and mould-release agents (Plastics Additives Handbook, 5th Edition, Hanser-Verlag, Munich, 2001, pp. 535-541, 546-548), antistatic agents (Plastics Additives Handbook, 5th Edition, Hanser-Verlag, Munich, 2001, pp. 627-636), additives for increasing electrical conductivity (Plastics Additives Handbook, 5th Edition, Hanser-Verlag, Munich, 2001, p. 630), and also dyes and pigments (Plastics Additives Handbook, 5th Edition, Hanser-Verlag, Munich, 2001, pp. 813-818, 823, 872-874). The additives E) can be used alone or in a mixture or in the form of masterbatches.

Preferred stabilizers are heat stabilizers and UV stabilizers. Preferred stabilizers are copper halides, preferably chlorides, bromides, and iodides in conjunction with halides of alkali metals, preferably halides of sodium, of potassium and/or of lithium, and/or in conjunction with hypophosphorous acid or with an alkali metal hypophosphite or alkaline earth metal hypophosphite, and also sterically hindered phenols, hydroquinones, phosphites, aromatic secondary amines, such as diphenylamines, substituted resorcinols, salicylates, benzotriazoles or benzophenones, and also variously substituted representatives of these groups or a mixture of these.

Particularly preferred stabilizers are mixtures made of a copper iodide, of one or more halogen compounds, preferably sodium iodide or potassium iodide, or of hypophosphorous acid or of an alkali metal hypophosphite or alkaline earth metal hypophosphite, where the individual components of the stabilizer mixture added are such that the molar amount of halogen present in the moulding composition is greater than or equal to six times the molar amount and less than or equal to fifteen times, preferably twelve times, the molar amount of copper present in the moulding composition, and the molar amount of phosphorus is greater than or equal to the molar amount of copper present in the moulding composition and less than or equal to ten times, preferably five times, the molar amount of copper present in the moulding composition.

Pigments or dyes preferably used are carbon black and/or nigrosine base.

Nucleating agents that can preferably be used are sodium phenylphosphinate or calcium phenylphosphinate, aluminium oxide, silicon dioxide, and also preferably talc powder.

Lubricants and mould-release agents that can preferably, be used are ester waxes, pentaerythritol tetrastearate (PETS), long-chain fatty acids, preferably stearic acid or behenic acid, or fatty acid esters, or fatty acid salts, preferably Cu stearate or Zn stearate, and also amide derivatives, preferably ethylenebisstearamide or montan waxes, and preferably mixtures made of straight-chain, saturated carboxylic acids having chain lengths of from 28 to 32 carbon atoms, and also low-molecular-weight polyethylene waxes and low-molecular-weight polypropylene waxes.

Preferred additives that can be added to increase electrical conductivity are conductive or other carbon blacks, graphite, and also other conventional, non-fibrous additives for increasing electrical conductivity. Nanoscale additives that can preferably be used are those known as “single-wall carbon nanotubes” or “multiwall carbon nanotubes”.

The moulding compositions to be used to produce products, components or mouldings according to the invention can moreover comprise constituents which have one or more dimensions smaller than 100 nanometres. These can be organic or inorganic, natural or synthetic, and combinations of various nanomaterials can also be used.

The moulding compositions to be used according to the invention are processed via known processes to give the desired products, components, mouldings, moulded parts or semifinished products, preferably via injection moulding, extrusion, profile-extrusion processes or blow moulding, where blow moulding particularly preferably means standard extrusion blow moulding, 3D extrusion blow moulding, the suction blow moulding process and sequential coextrusion.

These processes for producing products, components, moulded parts, mouldings or semifinished products via extrusion or injection moulding operate at melt temperatures in the range from 220 to 330° C., preferably from 230 to 300° C., and also optionally at pressures of at most 2500 bar, preferably at pressures of at most 2000 bar, particularly preferably at pressures of at most 1500 bar and very particularly preferably at pressures of at most 750 bar.

A feature of the injection-moulding process is that the raw material, preferably in pellet form, is melted (plastified) in a heated cylindrical cavity and is injected in the form of injection-mouldable melt into a temperature-controlled cavity. Once the melt has cooled (solidified), the injection-moulded part is demoulded.

A distinction is made between the following steps within the injection-moulding process:

1. Plastification/melting

2. Injection phase (injection procedure)

3. Hold-pressure phase (for thermal contraction during crystallization)

4. Demoulding

An injection-moulding machine is composed of a clamping unit, the injection unit, the drive and the control system. The clamping unit has fixed and movable platens for the mould, an end platen, and also tie bars and drive for the movable mould platen (toggle assembly or hydraulic clamping unit).

An injection unit encompasses the electrically heatable cylinder, the screw drive (motor, gearbox) and the hydraulic system for displacing the screw and injection unit. The function of the injection unit consists in melting, metering and injecting the powder or the pellets and applying hold pressure thereto (followed for contraction). The problem of reverse flow of the melt within the screw (leakage flow) is solved via non-return valves.

Within the injection mould, the inflowing melt is then separated and cooled, and the required component or product or moulding is thus manufactured. Two mould halves are always needed for this process. A distinction is made between the following functional systems within the injection-moulding process:
runner system
shaping inserts
venting
force-absorption system at end of machine
demoulding system and transmission of movement
temperature control

In contrast to injection moulding, in extrusion the extruder, which is a machine for producing shaped thermoplastics, produces a continuous plastics extrudate, in this case a polyamide. A distinction is made between

single-screw extruders and twin-screw extruders, and also the respective subgroups of

conventional single-screw extruders, conveying single-screw extruders,

contrarotating twin-screw extruders and corotating twin-screw extruders.

Extrusion plants are composed of extruder, die, downstream equipment and extrusion blow moulds. Extrusion plants for producing profiles are composed of: extruder, profile die, calibrator, cooling section, caterpillar take-off and roller take-off, separation device and tilting chute.

For the purposes of the present invention, profiles are components or parts which have identical cross section through their entire length. They can be produced by the profile extrusion process. The fundamental steps in the profile extrusion process are:
1. Plastification and provision of the thermoplastic melt in an extruder.
2. Extrusion of the thermoplastic melt extrudate through a calibrating envelope which has the cross section of the required profile.
3. Cooling of the extruded profile on a calibrating table.
4. Onward transport of the profile using a take-off behind the calibrating table.
5. Cutting the continuous profile to length in a cutter system.
6. Collecting the cut-to-length profiles on a collection table.

A description of profile extrusion of nylon-6 and nylon-6,6 is given in Kunststoff-Handbuch [Plastics handbook] 3/4, Polyamide [Polyamides], Carl Hanser Verlag, Munich 1998, pp. 374-384.

For the purposes of the present invention, blow moulding processes are preferably standard extrusion blow moulding, 3D extrusion blow moulding, suction blow moulding processes and sequential coextrusion.

According to Thielen, Hartwig, Gust, “Blasformen von Kunststoffhohlkörpern” [Blow moulding of plastics], Carl Hanser Verlag, Munich 2006, pp. 15 to 17, the fundamental steps of the standard extrusion blow moulding process are:
1. Plastification and provision of the thermoplastic melt in an extruder.
2. Deflection of the melt to flow vertically downward and shaping of a tubular melt “parison”.
3. Using a mould, the blow mould, generally composed of two half shells, to enclose the parison, freely suspended below the head.
4. Insertion of a blowing mandrel or of one (or more) blowing pin(s).
5. Blowing of the plastic parison onto the cooled wall of the blow mould, where the plastic cools and hardens, and assumes the final shape of the moulded part.
6. Opening of the mould and demoulding of the blow-moulded part.
7. Removal of the pinched-off “flash waste” at both ends of the blow-moulded part.

Other downstream operations can follow.

Standard extrusion blow moulding can also be used to produce components with complex geometry and multiaxial curvature. However, the resultant moulded parts then comprise a high proportion of excess, pinched-off material and have large regions with a pinch-off weld.

To avoid pinch-off welds and to reduce materials usage, 3D extrusion blow moulding, also termed 3D blow moulding, therefore uses specific devices to deform and manipulate a parison with diameter appropriately adapted to the cross section of the item, and then introduces this directly into the cavity of the blow mould. The extent of the remaining pinch-off edge is therefore reduced to a minimum at the ends of the item (Thielen, Hartwig, Gust, “Blasformen von Kunststoffhohlkörpern” [Blow moulding of plastics], Carl Hanser Verlag, Munich 2006, pp. 117-122).

In suction blow moulding processes, the parison is conveyed directly from the tubular die head into the closed blow mould and “sucked” through the blow mould by way of an air stream. Once the lower end of the parison emerges from the blow mould, clamping elements are used to pinch off the upper and lower ends of the parison, and the blowing and cooling procedure then follows (Thielen, Hartwig, Gust, “Blasformen von Kunststoffhohlkörpern” [Blow moulding of plastics], Carl Hanser Verlag, Munich 2006, p. 123).

In sequential coextrusion, two different materials are extruded in alternating sequence. The result is a parison with sections of different materials constitution in the direction of extrusion. By selecting appropriate materials it is possible to equip particular sections of the item with specifically required properties, for example for items with soft ends and hard central section or with integrated soft bellows regions (Thielen, Hartwig, Gust, “Blasformen von Kunststoffhohlkörpern” [Blow moulding of plastics], Carl Hanser Verlag, Munich 2006, pp. 127-129).

The process for improving products, mouldings, components or moulded parts in motor vehicles in respect of their resistance to crankcase gases and/or constituents of those is characterized by the following steps:
1) Production of products, mouldings, components or moulded parts by means of profile extrusion or other extrusion processes, blow moulding processes, in particular standard extrusion blow moulding, 3D extrusion blow moulding, suction blow moulding processes and sequential coextrusion, or injection moulding from moulding compositions comprising
   A) from 40 to 98.98 parts by weight of at least one polyamide and/or copolyamide,
   B) from 1 to 10 parts by weight, preferably from 2 to 8 parts by weight, particularly preferably from 3 to 6 parts by weight, of at least one copolymer comprising at least one olefin, preferably a-olefin, and at least one methacrylate or acrylate of an aliphatic alcohol, where the MFI (Melt Flow Index) of the copolymer B) is greater than 10 g/10 min and the MFI is determined or measured at 190° C. using a load of 2.16 kg,
   C) from 0.01 to 10 parts by weight, preferably from 0.1 to 6 parts by weight, particularly preferably from 0.5 to 5 parts by weight, of at least one di- or polyfunctional additive which has branching or chain-extending effect and which comprises, per molecule, at least two and at most 15 functional groups which have branching or chain-extending effect, and
   D) from 0.01 to 40 parts by weight, preferably from 5 to 39 parts by weight, particularly preferably from 15 to 35 parts by weight, of at least one impact modifier differing from components B) and C) and
2) incorporation of the products, mouldings, components or moulded parts, produced according to 1), in the form of air-conducting components or constituents of air-conducting components in motor vehicles, in particular in internal combustion engines of these, preferably in the form of clean-air lines, charge-air pipes, in particular charge-air feed line, or in the form of charge-air return line, intake pipes, crankcase vents or transmission vents.

It will be understood that the specification and examples are illustrative but not limitative of the present invention and that other embodiments within the spirit and scope of the invention will suggest themselves to those skilled in the art.

### EXAMPLES

In order to demonstrate the improvements described according to the invention, appropriate plastics moulding compositions were first prepared by compounding. The individual components were mixed at temperatures of from 260 to 300° C. in a twin-screw extruder (ZSK 26 Mega Compounder from Coperion Werner & Pfleiderer, Stuttgart, Germany), discharged in the form of extrudate into a water bath, cooled until pelletizable and pelletized.

An ARBURG-520 C 200-350 injection-moulding machine was used with the melt temperatures and mould temperatures specified in Table 2 to injection-mould test specimens (80×10×4 mm flat specimens and 170×10×4 mm dumbbell specimens) of the moulding composition of Example 1 according to the invention, and also moulding compositions of the comparative examples.

Test T1 serves to determine resistance to constituents of crankcase gases. Test T2 serves as model system for determining resistance to aqueous, acidic phases which can be constituents of crankcase gases.

Test T1:

The initial values were determined by carrying out the Shore D hardness test using a method based on DIN 53503 on a 170×10×4 mm dumbbell specimen shortly after injection moulding.

An 80×10×4 mm flat specimen was aged for visual assessment. Five further 170×10×4 mm dumbbell specimens were weighed shortly after injection moulding to determine initial mass and were then aged as follows:

The test specimens were aged in 1 molar nitric acid at 60° C. for 4 h in a glass vessel with ground flange and stopper in an oven. The test specimens were then rinsed with distilled water and dabbed to remove remaining adhering liquid, and dried at room temperature for 30 min. The test specimens were then aged in Lubrizol 05 304 206 reference engine oil at 135° C. for 18 h in a glass beaker sealed by a watch glass. At the end of the exposure time, a paper tissue was used to remove adhering test liquid from the test specimens and they were aged at room temperature for 30 min. This was then followed by 30 minutes of ageing in DIN 51604-2—B FAM test liquid (=FAM 2) at room temperature. At the end of the fuel-ageing process, the test specimens were aged in air at room temperature for 30 min, and the test cycle was repeated.

The ageing process was terminated once the third test cycle had concluded. Five 170×10×4 mm dumbbell specimens were again weighed, and an 80×10×4 mm flat specimen was visually assessed.

One of these aged 170×10×4 mm dumbbell specimens was subjected to the Shore D hardness test using a method based on DIN 53503. The effect according to the invention is clear from Table 2.

Test T2:

The initial values were determined by carrying out the ISO 527 tensile test on 5 170×10×4 mm dumbbell specimens shortly after injection moulding. Five further 170×10×4 mm dumbbell specimens were weighed shortly after injection moulding to determine initial mass and were then aged as follows:

The 170×10×4 mm dumbbell specimens were aged in test liquid A at 80° C. for 100 h in a glass vessel with ground flange and stopper in an oven. Test liquid A was produced by dissolving 260 mg of sodium sulphate, 20 mg of lactic acid, 90 mg of 99% formic acid, 540 mg of 99% acetic acid, 1100 mg of 65% nitric acid and 50 mg of 35% hydrochloric acid in 1000 mL of demineralized water at room temperature, with stirring. The 170×10×4 mm dumbbell specimens were then rinsed with distilled water, dabbed to remove remaining adhering liquid, and aged in test liquid B at 80° C. for 2000 h in a glass vessel with ground flange and stopper in an oven. Test liquid B was produced by dissolving 260 mg of sodium sulphate, 100 mg of lactic acid, 210 mg of 99% formic acid, 400 mg of 99% acetic acid, 85 mg of sodium chloride and 85 mg of sodium citrate in 1000 mL of demineralized water at room temperature, with stirring. At the end of the exposure time, the 170×10×4 mm dumbbell specimens were rinsed with distilled water; a paper tissue was used to remove adhering test liquid from the specimens, and they were aged at room temperature for 30 min.

The 170×10×4 mm dumbbell specimens were then weighed again to determine the increase in weight and were visually assessed.

The said 170×10×4 mm dumbbell specimens were then dried at 80° C. for four days in a vacuum oven. The ISO 527 tensile test was then carried out at room temperature.

TABLE 2
Examples according to the invention
The table below states the amounts of the starting materials
in parts by weight and the effects according to the invention.

| | | Inventive | | | |
|---|---|---|---|---|---|
| | | Example 1 | Comparison 1 | Comparison 2 | Comparison 3 |
| Copolyamide ¹⁾ | [%] | 59.4 | | | |
| Ethylene acrylate copolymer ²⁾ | [%] | 5 | | | |
| Epoxidized soya oil ³⁾ | [%] | 3 | | | |
| Impact modifier ⁴⁾ | [%] | 30 | | | |
| Additives ⁵⁾ | [%} | 2.6 | | | |
| Injection-moulding melt | [° C.] | 280 | 260 | 240 | 240 |
| temperature | | | | | |
| Injection-moulding mould | [° C.] | 80 | 80 | 45 | 45 |
| temperature | | | | | |
| Test T1: | | | | | |
| Visual assessment ⁶⁾ | | + | −− | −− | − |
| Increase in weight ⁷⁾ | [%] | 4.3 | 23.7 | 10.0 | 7.9 |
| Shore D hardness prior to ageing ⁸⁾ | | 62 | 49 | 48 | 52 |
| Shore D hardness after ageing ⁸⁾ | | 58 | 32 | 43 | 45 |
| Reduction in Shore D hardness | [%] | 6.4 | 34.7 | 10.4 | 13.5 |
| after ageing ⁸⁾ | | | | | |
| Test T2: | | | | | |
| Visual assessment ⁶⁾ | | + | − | −− | −− |
| Increase in weight ⁷⁾ | [%] | 3.5 | 6.2 | 29.1 | 12.6 |
| Tensile strength prior to ageing ⁹⁾ | [MPa] | 41 | 24 | 30 | 36 |
| Tensile strength after ageing ⁹⁾ | [MPa] | 33 | 23 | 17 | 18 |
| Reduction in tensile strength after | [%] | 19.5 | 4.2 | 43.3 | 50 |
| ageing ⁹⁾ | | | | | |

Comparison 1: elastomeric block copolyamide from EMS (Grilon ® ELX 50 H NZ, ISO 1874 name: PA6/X-HI, BGH, 32-002)
Comparison 2: thermoplastic polyester elastomer from DuPont Engineering Polymers (Hytrel ® HTR8441 BK316, ISO 1043 name: TPC-ET)
Comparison 3: thermoplastic polyester elastomer from DuPont Engineering Polymers (Hytrel ® HTR4275 BK316, ISO 1043 name: TPC-ET)
¹⁾ PA 6/66 copolyamide (polymerized from 95% of caprolactam and 5% of AH salt of adipic acid and hexamethylenediamine) with relative viscosity η rel from 2.85-3.05, measured on a 1% by weight solution in meta-cresol at 25° C.
²⁾ copolymer of ethene and 2-ethylhexyl acrylate with 63% by weight ethene content and with MFI 550
³⁾ corresponds to CAS 8013-07-8
⁴⁾ maleic anhydride-modified ethylene/propylene copolymer
⁵⁾ other additives, such as colorants, stabilizers, mould-release agents
⁶⁾ visual assessment on aged test specimens using the following criteria:
“+”: no surface damage and no blistering
“−”: visible surface damage or visible blistering
“−−”: very clearly visible surface damage or very clearly visible blistering
⁷⁾ gravimetric determination in each case on 5 test specimens
⁸⁾ measured by a method based on DIN 53503 in each case on a 170 × 10 × 4 mm dumbbell specimen
⁹⁾ measured to ISO 527 in each case on 5 170 × 10 × 4 mm dumbbell specimens

Test specimens of the moulding composition of Example 1 according to the invention exhibit a markedly smaller weight increase due to absorption of test fluid and markedly less surface damage after test T1 or test T2 than test specimens of comparative Examples 1, 2 and 3.

Furthermore, the moulding composition of Example 1 according to the invention exhibits smaller decreases of Shore D hardness after test T1 than comparative Examples 1, 2 and 3, and also exhibits smaller decreases in tensile strength after test T2 than comparative Examples 2 and 3.

What is claimed is:

1. A process for improving products, mouldings, in motor vehicles in respect of their resistance to crankcase gases and/or constituents of those wherein
1) products, mouldings, components or moulded parts by means of extrusion, profile extrusion or other extrusion processes, blow moulding processes, in particular standard extrusion blow moulding, 3D extrusion blow moulding, suction blow moulding processes and sequential coextrusion, or injection moulding are used for moulding compositions comprising
A) from 40 to 98.98 parts by weight of at least one polyamide and/or copolyamide,
B) from 1 to 10 parts by weight, preferably from 2 to 8 parts by weight, particularly preferably from 3 to 6 parts by weight, of at least one copolymer comprising at least one olefin, preferably a-olefin, and at least one methacrylate or acrylate of an aliphatic alcohol, where the MFI (Melt Flow Index) of the copolymer B) is greater than 10 g/10 min and the MFI is determined or measured at 190° C. using a load of 2.16 kg,
C) from 0.01 to 10 parts by weight, preferably from 0.1 to 6 parts by weight, particularly preferably from 0.5 to S parts by weight, of at least one di- or polyfunctional additive which has branching or chain-extending effect and which comprises, per molecule, at least two and at most 15 functional groups which have branching or chain-extending effect, and
D) from 0.01 to 40 parts by weight, preferably from 5 to 39 parts by weight, particularly preferably from 15 to 35 parts by weight, of at least one impact modifier differing from components B) and C) and
2) incorporation of the products, mouldings, components or moulded parts, produced according to 1), into air-conducting components or constituents of air-conducting components in motor vehicles, in particular in internal combustion engines of these, preferably in the form of clean-air lines, charge-air pipes, in particular charge-air feed line, or in the form of charge-air return line, intake pipes, crankcase vents or transmission vents.

2. A process according to claim 1 wherein copolymer B) is composed of less than 4 parts by weight of monomer units which comprise other reactive functional groups selected from the group consisting of epoxides, oxetanes, anhydrides, imides, aziridines, furans, acids, amines, oxazolines.

3. A process according to claim 1 or 2, wherein in the copolymer B), the olefin is copolymerized with 2-ethylhexyl acrylate.

4. A process according to claim 3, wherein in the copolymer B), the olefin is ethene.

5. A process according to one of claims 1 to 4, wherein the MFI of the copolymer B) is greater than 150 g/10 min.

6. A process according to one of claims 1 to 5, wherein the di- or polyfunctional additives C) which have branching or chain-extending effect comprise, per molecule, at least two and at most 15 functional groups which have branching or chain-extending effect, where these have been selected from the group consisting of isocyanates, capped isocyanates, epoxides, maleic anhydride, oxazolines, oxazines, oxazolones.

7. A process according to one of claims 1 to 6, wherein the di- or polyfunctional additives C) which have branching or chain-extending effect have been selected from the group of the epoxidized vegetable oils.

8. A process according to claim 7, wherein as an epoxidized vegetable oil epoxidized soya oil is used.

9. A process according to one of claims 1 to 8, wherein in addition to A), B), C) and D), the moulding compositions also comprise E) from 0.001 to 5 parts by weight of at least one further additive differing from components B) to D).
